(19) United States
(12) Patent Application Publication
(10) Pub. No.: US 2006/0029695 A1
(43) Pub. Date: Feb. 9, 2006

(54) Multi-section food holding item exhibiting measurement indicia

(76) Inventor: Lytelia Kaczor, Riverview, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/912,326

(22) Filed: Aug. 5, 2004

(51) Int. Cl. A22C 17/10

(52) U.S. Cl. 426/87

(57) ABSTRACT

A container having a three-dimensional body exhibiting a length, width and depth, the body being subdivided into a plurality of individual and volume-defining compartments. A measurement indicia scheme applied in a depthwise extending fashion along a side wall associated with at least one of the volume-defining compartments. The compartments each holding a measured volume of a food item.

### BACKGROUND OF THE INVENTION

1. Field of the Invention

The present invention relates generally to divided dish containers. In particular, the present invention discloses a multi-sectioned food holding item which exhibits measurement indicia markings in association with at least one subdivided compartment in order to provide for measured and varied portions of given food items, such as is particularly useful for dietary planning.

2. Description of the Prior Art

The prior art is well documented with examples of food and beverage storage and dispensing devices. The objective in certain instances is to provide a container containing measured portions of a meal, such as is useful for dieters.

A first example drawn from the prior art is set forth in U.S. Pat. No. 6,296,488, issued to Brenkus et al., which teaches a diet method and apparatus including a plate exhibiting a plurality of compartments which are designed to enclose a specified volume of food. The apparatus is used with associated meal cards having a variety of foods listed and which correspond, by card subsection, with the compartments of the apparatus. The meal cards are positioned such that the food list for a particular compartment fits in the shape of the compartment such that the user can see the selectable food items which may be used to fill the corresponding compartment.

U.S. Design Pat. No. 480,929, issued to Douglas, illustrates a portable compartmented, multilayered and reusable food container. Additional examples of organizer trays are further illustrated in U.S. Design Pat. No. 459,078, issued to Tondino, and the partitioned food service assembly illustrated in U.S. Design Pat. No. 444,058, issued to Hampshire et al. Yet additional examples of storage containers are illustrated in U.S. Design Pat. No. 366,397 and U.S. Design Pat. No. 367,589, both issued to Zimmerman.

Utility U.S. Pat. No. 3,799,386, issued to Madalin et al., teaches an insulated covered serving tray assembly for the delivery and service of food, such assembly including a pair of insulated base and cover sections with a plurality of dishes retained therebetween. Handle recesses at opposite ends of the tray section facilitate the carrying and handling of the assembly and indicia means in the form of a folded card is clamped between the upper and lower sections with a portion of the card exposed externally to provide appropriate information concerning the menu, recipient, and the like.

U.S. Pat. No. 4,658,957, issued to Guth et al., teaches a utility tray including a plurality of holders sized to accommodate a removable sleeve or cap of a hypodermic syringe, once the syringe is to be prepared for administration of medication. Each holder is arranged relative to indicia to remind a user of the number of doses of medication administered. The tray further includes a waste disposal depository, a syringe rest and various storage compartments.

Finally, U.S. Pat. No. 4,165,855, issued to Mason, Jr., teaches a cooking utensil kit including a large, generally circular mixing bowl and a truncated shape center post having a height approximately the same as the sides of the bowl and adapted to serve as a container. A generally hemispherical knob formed at the center of the base of the bowl and post has a complementary hemispherical indentation in its base. The post is adapted to be centered in the bowl at the knob so that it may be plunged into the batter in the bowl and the bowl may then be used as a pan for preparing ring-shaped foods. A serving dish also exhibits a knob formed at the center of its base which is adapted to receive and center the post. A trivet is supported upon either the bowl or the dish, an outer rim of which is shaped to complement the inner surface of the bowl, and may be elevated within the bowl by rotating relative to the bowl.

### SUMMARY OF THE PRESENT INVENTION

The present invention discloses a multi-section divided container for use in providing measured quantities of food items. The divided dish container includes, in a preferred embodiment, individual compartments for both food and beverage, and further such that any one or more of the subdivided compartments includes individual volumetric measurement indicia. In particular, the present invention makes possible the ability to apportion different volumes of food and beverage items, all within one enclosed unit, to provide for a wide range of applicability of the dish container, such as in particular for dietary purposes.

A primary embodiment teaches a three-dimensional base with an affixably securable lid. The base includes first and second triangular-shaped compartments and a third rectangular-shaped compartment. Each of the compartments includes measurement indicia markings extending substantially vertically along a side wall associated with the given compartment. Additional circular compartments are provided and correspond to such as (sauce) cup holders, each of the circular compartments likewise including measurement indicia extending along a vertical surface thereof. Individual lids are further provided for the circular cup portions.

Additional variants of the dividing dish exhibit different sizes and configurations, such as which are useful in storing pre-measured volumes of food or beverage items. A further variant of the invention contemplates the use of one or more dividers, which are installed within an individual compartment in order to provide a subdivided volume within the associated compartment.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of a multi-sectioned food holding item with individual compartments and further exhibiting measurement indicia scales according to a first preferred embodiment of the present invention;

FIG. 2 is a multi-sectioned food holding item according to a further preferred embodiment of the present invention which exhibits a divider element installed within a given compartment; and

FIG. 3 is multi-sectioned food holding item according to yet a further preferred embodiment of the invention.

### DETAILED DESCRIPTION OF THE PREFERRED EMBODIMENTS

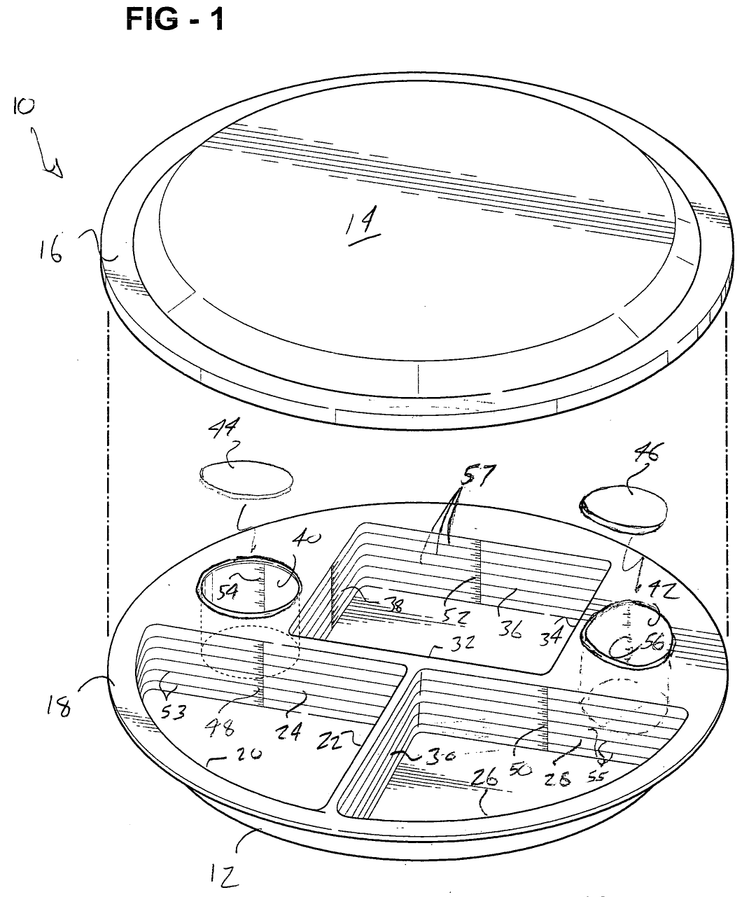

Referring now to FIG. 1, an exploded illustration is shown at 10 of a container according to a first preferred embodiment of the present invention. As previously described, the present invention teaches an improved item for providing precise and varied measured volumes of edible items, such as are particularly useful for dietary planning and the like.

Referring again to FIG. 1, the container includes a three-dimensional body 12 in combination with an attachable and sealable/resealable lid 14 exhibiting a lip edge 16 engageable with an outer associated annular rim 18 of the body 12. In the preferred embodiment, the body 12 is in the form of a circular cross-sectional saucer, or dish shape, however it is also envisioned that other container shapes may be employed within the scope of the invention, among these including square (rectangular), triangular, or any other suitable polygonal shape exhibiting any number of sides extending to infinity (defining in this instance a circular shape).

The body 12 and lid 14 are constructed of a plastic, typically polypropylene material, however it is understood that each may be constructed of any suitable material exhibiting the necessary properties of durability and resiliency. It is also envisioned that a sanitary plastic can be utilized in the construction of the body and lid and can also be constructed of an oven and/or microwave-safe material. It is further envisioned that the container can include either a reusable or throwaway device.

The container body 12 includes a plurality of individual volume-defining compartments, including first and second triangular-shaped compartments defined within a first semicircular portion of the body and exhibiting inwardly and interconnected surfaces, see at 20, 22 and 24 for first triangular-shaped compartment and at 26, 28 and 30 for second triangular-shaped compartment. The outermost side walls 20 and 26 respectively define arcuate-shaped surfaces corresponding to the outer circular profile of the divided dish body 12.

A further semicircular shaped portion of the body 12 includes a rectangular-shaped compartment defined by four inwardly and interconnected surfaces, see at 32, 34, 36 and 38. It is also envisioned that sauce cup holders, these including circular side walls 40 and 42, can be defined on opposite sides of the rectangular-shaped compartment. Associated lids 44 and 46 are attachable over the circular formed compartments and it is also envisioned that either underside locations of the lids (or associated annular upper edge locations of the circular compartments) can be appropriately configured for affixably securing the lids in place.

One significant aspect of the present invention is the ability to provide for precise and individualized storage of a desired volume of such as an edible food item. To accomplish this task, a measurement indicia scheme is applied in depthwise extending fashion along a side wall associated with at least one, and preferably all, of the volume-defining compartments.

In particular, such indicia schemes are illustrated at 48, in association with inwardly extending side wall 24 (first triangular-shaped compartment); at 50, in association with inwardly extending side wall 28 (second triangular-shaped compartment); at 52, in association with inwardly extending side wall 36 (rectangular-shaped compartment); at 54, in association with first depthwise extending circular (e.g., small sauce cup) compartment; and, finally, at 56 in association with the second depthwise extending circular compartment. It is also envisioned that the measurement indicia scheme may be applied in either English or metric measurements.

As is also evident in FIG. 1, individual sets of horizontal reference lines are provided in relation to each of the measurement indicia schemes and, by example, such lines are shown at 53 for scheme 48, at 55 for scheme 50 and at 57 for scheme 52. The sets of reference lines are intended to complement the indicia schemes in order to better assist in determining a correct volumetrically defined amount of an item to be deposited into the compartment.

In a preferred application, the multi-sectioned divider dish may exhibit dimensions such as 8″ length×7⅝″ width×2″ height. The two triangular-shaped sections may hold 1 c total and may also be subdivided for a ½ c portion, whereas the rectangular section holds such as a 3 oz serving for protein. The circular-shaped compartments 40 and 42 may also serve as holding compartments for precise volumetric measurements of such as salad dressings and the like. A feature of the present invention again being the ability to measure and store any desired item, in any of the selected compartments, according to a desired (and non-standardized) volume.

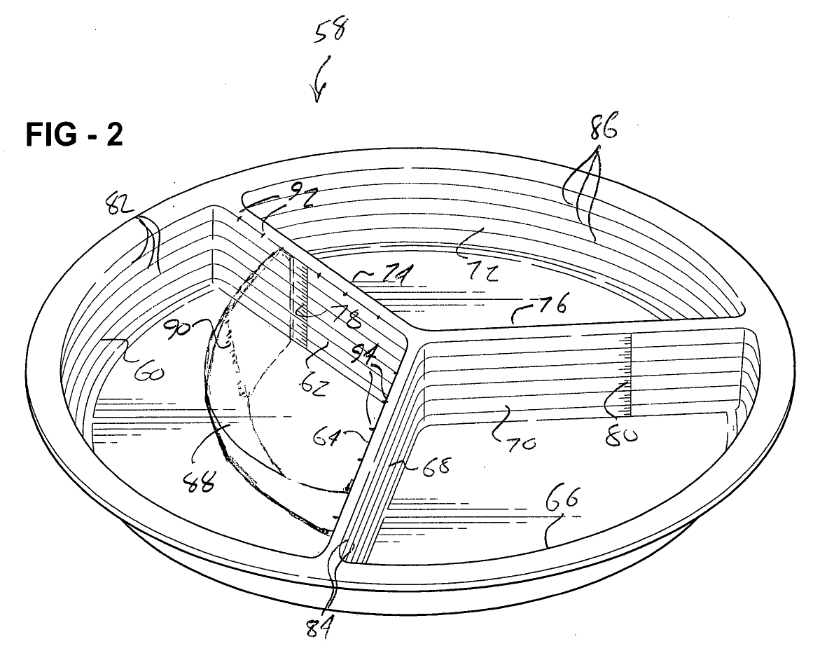

Referring to FIG. 2, a further example is generally illustrated at 58 of a container body according to a further preferred embodiment of the present invention. The body 58 is substantially functionally the same as was previously described in reference to item 12 in FIG. 1, the notable difference being that the circular cross section is divided into first, second and third triangular-shaped compartments (see sets of inwardly facing and interconnecting surfaces 60, 62 and 64; 66, 68 and 70; and, finally 72, 74 and 76). Measurement indicia schemes are further identified at 78 and 80 in association with selected surfaces 76 and 70 of two compartments. Additional pluralities of reference lines are further defined at 82, 84 and 86, in association with each of the three triangular subdivided compartments, which establish additional reference lines for facilitating the precise measuring of items to be deposited into the compartments.

An additional feature illustrated in the variant 58 of FIG. 2 is the use of one or more dividers, see for example arcuate-shaped and elongated divider 88, which are installed within an individual compartment (in this case that defined by interior facing surfaces 60, 62 and 64) in order to provide a subdivided volume within the associated compartment. It is further envisioned that a measurement indicia scheme may be applied, such as again in depthwise extending fashion, along a surface of the elongated divider, this being illustrated at 90. Additional grid markings (at 92 and 94) may be provided in incremental and radial locations, and such as along surfaces associated with inner side walls 62 and 64, the purpose for which being to correspond to selected and insertable dividers in order to establish varying subdivided volumes within the compartment.

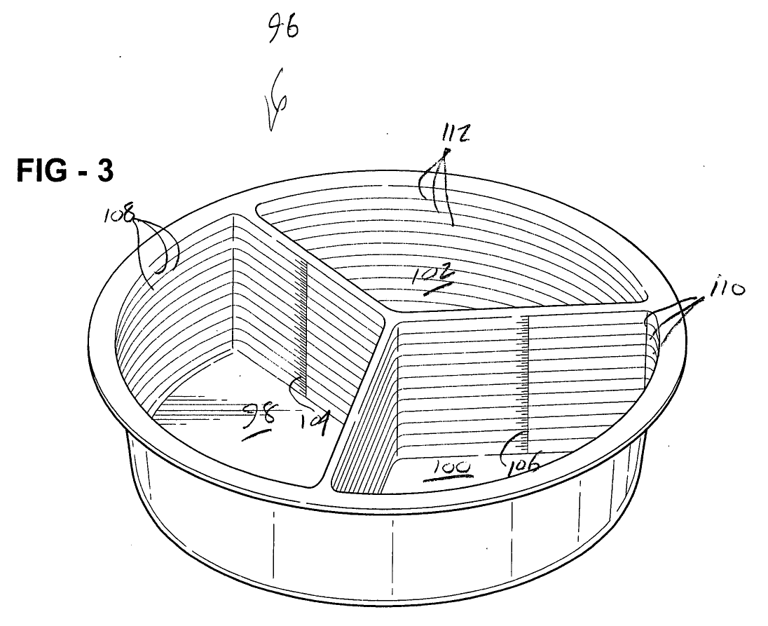

Referencing finally FIG. 3, a further example is shown at 96 of a container body according to a further preferred embodiment. The body 96 in this variant defines a deeper and larger sized container, the purposes for which including the ability to store larger pre-measured volumes of edibles and the like. As with the embodiment of FIG. 2, a lid (not shown) may again be secured over the open top of the body in order to seal/reseal its interior.

Triangular-shaped compartments are referenced generally at 98, 100 and 102, each including individual and depthwise extending measurement indicia schemes (see at 104 and 106 for compartments 98 and 100), as well as individual sets of reference lines 108, 110 and 112. As previously described, other and additional shapes, sizes and configurations can be employed within the scope of the present invention.

Having described my invention, other and additional preferred embodiments will become apparent to those skilled in the art to which it pertains without deviating from the scope of the appended claims.

I claim:

1. A container, comprising:
a three-dimensional body exhibiting a length, width and depth;
said body being subdivided into a plurality of individual and volume-defining compartments; and
a measurement indicia scheme being applied in a depthwise extending fashion along a side wall associated with at least one of said volume-defining compartments;
said compartment holding a measured volume of at least a food item.

2. The container as described in claim 1, further comprising a lid releasably affixable to said body.

3. The container as described in claim 1, said body exhibiting a specified shape and size and further comprising a substantially saucer shape configuration.

4. The container as described in claim 1, further comprising a plurality of first, second and third triangular-shaped and three-dimensional compartments.

5. The container as described in claim 1, further comprising first and second triangular-shaped compartments defined within a first semicircular portion of said saucer, and a rectangular-shaped compartment defined within a second semicircular portion of said saucer.

6. The container as described in claim 5, further comprising first and second circular-shaped compartments defined within said second semicircular portion.

7. The container as described in claim 1, further comprising a measurement indicia scheme applied along each of said volume defining compartments.

8. The container as described in claim 1, further comprising an elongated and arcuate-shaped divider installed within a selected compartment in order to define a subdivided volume within the associated compartment.

9. The container as described in claim 8, further comprising a measurement indicia scheme applied in depthwise extending fashion along a surface of said arcuate-shaped divider.

10. The container as described in claim 1, said body exhibiting a specified shape and size and being constructed of a durable plastic.

11. The container as described in claim 1, said body exhibiting a substantially circular cross-sectional shape and further comprising a polypropylene material.

12. The container as described in claim 6, further comprising first and second lids associated with said circular-shaped compartments.

13. A container, comprising:
a three-dimensional body exhibiting a length, width and depth;
said body being subdivided into a plurality of individual and volume-defining compartments;
a measurement indicia scheme being applied in a depthwise extending fashion along a side wall associated with each of said volume defining compartments; and
a lid releasably affixable to said body;
each of said compartments capable of holding different measured volumes of at least a food item.

14. The container as described in claim 13, further comprising at least one sauce cup compartment defined within said body, a further measurement indicia scheme being applied in a depthwise extending fashion along a side wall associated with said sauce cup compartment.

15. The container as described in claim 13, further comprising at least one circular-shaped compartment associated with said body.

16. The container as described in claim 15, further comprising a lid associated with said circular-shaped compartment.

17. The container as described in claim 13, further comprising an elongated and arcuate-shaped divider installed within a selected compartment in order to define a subdivided volume within the associated compartment.

18. The container as described in claim 1, said body exhibiting a specified shape and size and being constructed of a plastic material including at least polypropylene.

19. The container as described in claim 13, said body exhibiting a specified shape and size, said volume defining-compartments each exhibiting a specified and polygonal shape.

20. A container, comprising:
a three-dimensional body exhibiting a length, width and depth, said body exhibiting a substantially circular shape in cross section;
said body being subdivided into a plurality of individual and volume-defining compartments selected from a group including at least one of circular, triangular and square-shaped compartments;
a measurement indicia scheme being applied in a depthwise extending fashion along a side wall associated with at least one of said volume-defining compartments; and
a lid releasably affixable to said body;
each of said compartments capable of holding a measured volume of at least a volume definable and edible item.
